(19) United States
(12) Patent Application Publication
(10) Pub. No.: US 2025/0328401 A1
(43) Pub. Date: Oct. 23, 2025

(54) Quantum Transformation Based Correlated Relationship Extraction for Failure Preemption & Predictive Analytics

(71) Applicant: Bank of America Corporation, Charlotte, NC (US)

(72) Inventors: Sreeram Raghavan, Chennai (IN); Venkata Siva Nageswara Rao Kolusu, Hyderabad (IN); Pushkar Taneja, Hyderabad (IN); Yash Pant Dashputra, Hyderabad (IN)

(21) Appl. No.: 18/581,585

(22) Filed: Feb. 20, 2024

(51) Int. Cl. G06F 11/00

(52) U.S. Cl. CPC G06F 11/004; G06F 2201/805

(57) ABSTRACT

The present invention introduces an advanced system and method for predictive maintenance and fault detection, leveraging the synergistic potential of quantum computing and graph transformer networks. This innovation collects and preprocesses data from diverse sources through edge computing, enriching this data with supplemental information to construct a comprehensive operational dataset. Utilizing an ontology-based framework, the system organizes the data into a knowledge graph, which is then analyzed using quantum computing techniques to uncover complex, correlated relationships. The extracted relationships are further analyzed by a Graph Transformer Network (GTN) equipped with a multi-head attention mechanism, enabling the identification of spatio-temporal patterns indicative of potential system faults. The system classifies these patterns to distinguish between normal operation, potential faults, and outliers, facilitating proactive maintenance actions. This invention represents a significant advancement in the field of predictive maintenance, offering improved reliability, efficiency, and operational insight for complex systems.

### TECHNICAL FIELD

The present disclosure relates to Data Processing: Artificial Intelligence and, more particularly, to predictive analytics and machine learning to analyze voluminous complex datasets. This involves developing algorithms capable of identifying, analyzing, and predicting failure patterns within diverse data sources, and providing preemptive recommendations to mitigate potential issues. The invention leverages advanced AI techniques to enhance decision-making processes and operational efficiency across various technological platforms.

### DESCRIPTION OF THE RELATED ART

In the digital age, the exponential growth of data generated from a multitude of sources such as servers, desktops, laptops, and failover systems present a significant challenge. This data, while a potential goldmine of insights, is often fragmented and inconsistent, making it difficult to harness effectively for analysis and decision-making. The disparate nature of the data sources adds layers of complexity in aggregating and processing the information, highlighting the need for a robust solution that can handle such diversity.

The problem extends beyond mere volume; it encompasses the variety and velocity of data being produced. Each source contributes its unique format and type of data, ranging from structured databases to unstructured logs and multimedia files. This variety demands flexible and powerful analytical tools capable of understanding and processing different data types seamlessly, to extract valuable insights hidden within.

Furthermore, the potential of this vast data is largely untapped due to the lack of standardized frameworks for analysis. Current methodologies often fall short in integrating and interpreting data across platforms and technologies. This gap signifies a missed opportunity in predictive analytics, where patterns indicating potential system failures or inefficiencies could be identified and addressed proactively, enhancing operational resilience.

Developing a universal framework capable of analyzing this disparate data corpus is paramount. Such a framework would need to employ advanced techniques, possibly leveraging artificial intelligence and machine learning, to sift through the data, identify patterns, and predict future outcomes. The goal is to not only manage the data more effectively but also to enable preemptive actions that could mitigate risks and capitalize on opportunities, thereby driving strategic advantages.

The solution to this problem holds the key to unlocking the full potential of digital data, transforming challenges into opportunities for innovation and growth. By establishing a reliable and standardized system for data analysis, organizations can move towards a more data-driven approach, making informed decisions that could significantly improve performance and competitive edge in an increasingly data-centric world.

Hence there is a long felt and unsatisfied need to provide need for a dependable and universal framework capable of processing and analyzing vast data sets, regardless of their source, technology, or format. This framework would enable the identification and prediction of failure patterns within the data, facilitating the development of strategies to prevent such failures before they occur. Essentially, there is a need for preemptively addressing issues by leveraging data analysis to enhance decision-making and operational reliability.

### SUMMARY OF THE INVENTION

In accordance with one or more arrangements of the non-limiting sample disclosures contained herein, solutions are provided to address one or more of the above issues and problems by, inter alia: leveraging artificial intelligence and machine learning algorithms to analyze extensive datasets from various sources to identify and predict potential failure patterns. This process includes collecting disparate data, normalizing it for consistency, and then applying unsupervised learning techniques to detect anomalies and trends indicative of possible failures. By forecasting these failures, the system can recommend preemptive actions to avoid or mitigate their impact. This approach enables a proactive maintenance strategy, enhancing system reliability and performance across different technological platforms and environments.

The inventions disclosed herein involve creating a quantum sampling-based correlated relationship extraction mechanism and an unsupervised deep learning framework to analyze massive datasets. It aims to identify potential failure signatures by understanding the interconnections among data points, which are not apparent when viewed as discrete datasets. This is achieved by a quantum transformation-based data analysis, prediction, and classification platform that leverages a graph transformer network and quantum correlation to efficiently predict failures. The system incorporates edge computing for data collection, processes data through an artificial intelligence (AI)/machine learning (ML) engine for extracting key fields and relationships. It uses a graph transformer network to model failure propagation and predict faults, facilitating early warning and preemptive actions.

The solutions involve the development of an advanced framework integrating AI/ML algorithms specifically designed to process and analyze vast and complex datasets from a multitude of sources, including servers, desktops, and mobile devices. This system employs unsupervised learning to sift through data, recognizing patterns, anomalies, and trends that are often precursors to system failures or critical issues. By identifying these indicators early, the solution can forecast potential problems and recommend proactive measures. This predictive capability allows organizations to preemptively address issues, significantly reducing downtime and enhancing operational efficiency. Additionally, the framework's flexibility ensures it can adapt to various data types and sources, making it a versatile tool for predictive maintenance across diverse technological ecosystems.

The inventions disclosed herein a groundbreaking approach to predictive maintenance and fault detection within large and complex datasets. At its core, the inventions integrate quantum computing methodologies with advanced machine learning techniques to identify and predict potential system failures before they occur. This is facilitated through a quantum sampling-based correlated relationship extraction mechanism, which is paired with an unsupervised deep learning framework. These components work in tandem to analyze massive datasets, uncovering hidden relationships and interconnections among data points that traditional analysis methods might overlook.

The process begins with the collection of diverse data types, including logs and real-time data from various sources, which are then processed through edge computing analytics. This initial stage utilizes natural language processing techniques to parse logs and identify key entities, setting the stage for deeper analysis. The data, now structured and enriched with identified relationships, is ready for the next phase of processing, where the true power of the invention comes into play.

At the heart of the invention lies the quantum correlated relationship extraction mechanism. This mechanism employs quantum transformations to analyze the prepared data, extracting complex relationships and patterns through a combination of Hamiltonian transformations, parameterized quantum evolutions, and attention matrices. These quantum-based processes allow for a level of depth and efficiency in data analysis that is unparalleled by classical computing methods.

Following the quantum processing stage, the data is fed into a Graph Transformer Network (GTN), which utilizes a multi-head attention mechanism to further refine the analysis. The GTN models the extracted relationships within a knowledge graph, enabling the prediction of fault signatures through the analysis of spatio-temporal patterns and graph embeddings. This stage is relevant for understanding the propagation of potential faults and for identifying early warning signs of system failures.

A three-class data classifier categorizes the analyzed data into clean, fault, or outlier classes based on the identified fault signatures. This classification enables targeted predictive maintenance actions to be taken, reducing downtime, and preventing failures. By leveraging the combined power of quantum computing and graph transformer networks, the invention offers a novel and efficient approach to predictive analytics, with broad applications in industries reliant on complex systems and large datasets.

Sample innovative features disclosed herein include:
a. Quantum Correlated Relationship Extraction: This feature utilizes quantum mechanics principles to extract complex relationships within data. It feeds into a GTN, enhancing error prediction by analyzing a graph representation of components and historical error data. The Quantum Correlated Relationship Extraction utilizes principles of quantum mechanics to delve into complex, interconnected data patterns not easily discernible through classical computing methods. By harnessing quantum computational capabilities, it can efficiently identify nuanced relationships and dependencies within large datasets. This process is relevant for feeding into a GTN, which leverages these quantum-identified relationships to enhance its prediction of errors and failures. This approach allows for a more sophisticated analysis of component interactions and historical error data, significantly improving the accuracy and reliability of predictive models.
b. Graph Transformer Network with Physics-based Model: The knowledge graph acts as a physics-based model, improving the extractor's efficiency and the GTN's learning process. This aids in better generalization across different failure modes. The integration of a physics-based model into the GTN represents a novel approach to enhancing the network's learning process. By utilizing a knowledge graph that acts as a physics-based model, the system can more effectively simulate and understand complex interactions within data. This method significantly boosts the efficiency of the Quantum Correlated Relationship Extraction process. Moreover, it facilitates the GTN's ability to generalize across various failure modes, ensuring more accurate predictions in diverse scenarios by mimicking physical phenomena and interactions within its analytical framework.
c. Incremental Learning for Real-world Adaptability: The model's incremental learning capability makes it robust and adaptable to dynamic environments. This feature allows for the model to be extended to enterprise-wide applications. The model's incremental learning capability signifies its ability to learn and adapt over time, making it well-suited for dynamic, real-world environments. This adaptability ensures the model can continuously update its knowledge base and predictive accuracy as new data becomes available, without the need for complete retraining. This feature is particularly valuable for enterprise-wide applications, where data and operational conditions can vary significantly across different departments or functions, requiring a solution that can adjust and improve continuously.

These features collectively contribute to novel approaches for preempting failures and conducting predictive analytics by leveraging quantum computing and AI.

Considering the foregoing, the following presents a simplified summary of the present disclosure to provide a basic understanding of various aspects of the disclosure. This summary is not limiting with respect to the exemplary aspects of the inventions described herein and is not an extensive overview of the disclosure. It is not intended to identify key or critical elements of or steps in the disclosure or to delineate the scope of the disclosure. Instead, as would be understood by a personal of ordinary skill in the art, the following summary merely presents some concepts of the disclosure in a simplified form as a prelude to the more detailed description provided below. Moreover, sufficient written descriptions of the inventions are disclosed in the specification throughout this application along with exemplary, non-exhaustive, and non-limiting manners and processes of making and using the inventions, in such full, clear, concise, and exact terms to enable skilled artisans to make and use the inventions without undue experimentation and sets forth the best mode contemplated for carrying out the inventions.

In some arrangements, a method for predictive maintenance and fault detection in a computing environment involves several steps. Initially, it includes collecting source data and source logs from various data sources. This data is then preprocessed using an edge computing device to convert it into operational data, which is more suitable for in-depth analysis. Following this, the operational data is organized into a structured dataset through an ontology process, which establishes relationships among the data points. A knowledge graph is then generated from this dataset. Quantum computing techniques are applied to the knowledge graph to extract relationships that are quantum correlated, using processes such as Hamiltonian transformation and parameterized evolution. These quantum correlated relationships are analyzed using a Graph Transformer Network (GTN), which is equipped with a multi-head attention mechanism, to identify spatio-temporal patterns. Based on these patterns, a signature for the operational data is classified into a clean category, a potential fault category, or an outlier category. For signatures in the outlier category, the source data and logs are augmented with additional data and logs. The analysis continues for these augmented signatures until a new signature, that can be classified as either clean or potentially faulty, is generated. Finally, a corrective action is initiated for any signature classified in the potential fault category.

In some arrangements, a method for predictive maintenance and fault detection in a computing environment involves a series of steps beginning with the collection of operational data from a wide range of sources, such as computing devices, network equipment, and embedded systems. This data is then preprocessed using edge computing technologies, which enhance the data's suitability for in-depth analysis by structuring and refining it. To add further context to this operational data, supplemental data from external databases and services is integrated, enriching the dataset and enhancing the predictive analysis capabilities of the system.

Following the data augmentation, an ontology-based approach is employed to organize this enriched dataset into a structured form. This process establishes relationships and hierarchies among the data points, facilitating advanced analysis. From this organized dataset, a knowledge graph is generated, visually and computationally mapping out the relationships between entities to pinpoint interdependencies and potential failure points within the system.

To delve deeper into the complexities of the data, quantum computing techniques are applied to the knowledge graph. These techniques involve Hamiltonian transformation and parameterized evolution processes, which extract complex, non-obvious relationships and patterns that traditional computing methods might overlook. The quantum-extracted relationships are then analyzed using a Graph Transformer Network (GTN) equipped with a multi-head attention mechanism. This analysis identifies spatio-temporal patterns indicative of potential faults or system degradations, enabling the prediction of potential issues before they escalate.

Based on the patterns identified through the GTN's analysis, the data is classified into categories: normal operation, potential faults, and outliers. This classification provides actionable insights for preventive maintenance or further investigation, guiding the initiation of maintenance protocols or adjustments to system operations. These actions address the predicted faults, aiming to minimize downtime and prevent potential system failures.

To ensure the system's predictive maintenance and fault detection capabilities continue to improve, a feedback loop mechanism is incorporated. This mechanism monitors the effectiveness of the maintenance protocols and adjustments, enabling continuous learning and adaptation. By analyzing the outcomes of these actions, the system refines its predictive algorithms and maintenance strategies, enhancing its overall reliability and operational efficiency.

In some arrangements, a process for predictive maintenance and fault detection in complex systems encompasses a series of steps designed to comprehensively manage and mitigate system faults. This process begins with the collection of operational data from a wide range of sources, including computing devices, network equipment, and embedded systems, ensuring a detailed dataset that reflects the system's current operational state. The collected data is then processed using edge computing technologies, which structure and refine the data, enhancing its suitability for in-depth analysis. This structured operational data is further enriched by integrating supplemental information from external databases and services, adding additional context for more accurate predictions. An ontology-based approach is employed to organize the enriched dataset, establishing a framework of relationships and hierarchies among the data points, which facilitates advanced analysis. From this organized dataset, a knowledge graph is generated, visually and computationally mapping the relationships between entities to pinpoint interdependencies and potential failure points. Quantum computing techniques are applied to the knowledge graph to extract complex, non-obvious relationships and patterns, leveraging quantum mechanics' unique capabilities for data analysis. These quantum-extracted relationships are analyzed using a GTN equipped with a multi-head attention mechanism, enabling the identification of spatio-temporal patterns indicative of potential faults or system degradations. Finally, the analyzed data is classified into categories based on the identified patterns, distinguishing between normal operation, potential faults, and outliers, and generating actionable insights for preventive maintenance or further investigation. This comprehensive process underscores a proactive and nuanced approach to maintaining system integrity and operational efficiency, leveraging advanced computational and analytical techniques to predict and mitigate potential system failures.

In some arrangements, a method for predictive maintenance and fault detection within a system involves collecting data from a multitude of sources to ensure a comprehensive understanding of the system's operational state. This method further includes preprocessing the gathered data using an Edge Computing Analytics Data Collection Server, which is tasked with extracting data logs and organizing the collected data to facilitate more nuanced analysis. Additionally, the preprocessed data is augmented with supplemental data, enriching the dataset to enhance the predictive analysis capabilities of the system. Following this, the method involves merging the augmented data and applying an ontology process to systematically organize the data based on predefined relationships and hierarchies, thus preparing it for further examination. A knowledge graph is then generated from this organized data, serving to visualize and computationally represent the relationships and entities within the data, offering insights into potential points of failure. To delve deeper into the data's complexities, quantum correlated relationships are extracted from the knowledge graph through a Hamiltonian transformation followed by a parameterized evolution process, leveraging the unique capabilities of quantum computing to transform and evolve the data. An attention matrix is subsequently generated from the quantum processed data, highlighting significant correlations and relationships among data elements. This matrix is analyzed using a multi-head attention mechanism within a GTN, focusing on spatio-temporal patterns learned from the quantum-extracted relationships. The GTN employs multi-channel 1×1 convolution to further refine the attention matrix, optimizing the network's ability to synthesize and enhance features across various data channels. Fault signatures are identified based on the spatio-temporal patterns learned, with embeddings for nodes, edges, and the graph generated to encapsulate the essential features and relationships within the data. The method culminates in classifying the analyzed data into clean, fault, or outlier categories based on the identified fault signatures, thereby predicting potential system faults. Alerts for corrective action are generated, or documentation and reports are produced for further review, based on the data classification, enabling timely and informed maintenance interventions.

In some arrangements, the method incorporates the integration of supplemental data based on the outcomes of real-time monitoring, including the use of external databases, third-party data services, or additional information that is relevant to the system's operational context. This step enriches the preprocessed data with a broader contextual analysis capability, ensuring that the predictive analysis is not only based on internal operational data but also considers external factors and additional insights that can influence system performance and fault prediction accuracy.

In some arrangements, the enriched data from the edge computing server, augmented with supplemental data, undergoes an ontology process. This process involves defining a structured model that includes a set of categories, relationships, and rules, describing how entities within the system interact and relate to each other. This structured approach facilitates a more detailed and semantically rich generation of the knowledge graph, enabling a deeper understanding of the system's operational dynamics and potential failure points.

In some arrangements, the method leverages quantum mechanical properties through a quantum correlated relationship extraction process. Informed by the structured model developed during the ontology process, this step utilizes a Hamiltonian transformation followed by a parameterized evolution process to transform and evolve the data within a quantum computing framework. The aim is to uncover deep insights and non-linear relationships within the data, revealing significant correlations that might be overlooked by classical computing methods, thereby enhancing the system's predictive capabilities.

In some arrangements, the identification of fault signatures and the classification of the analyzed data into clean, fault, or outlier categories are based on the learned spatio-temporal patterns and embeddings generated from the quantum-extracted relationships. This classification process informs the generation of alerts for corrective action or the production of documentation and reports, enabling the system to adjust operational parameters preemptively in response to the predicted faults. This proactive approach aims to prevent system failures and maintain optimal system performance by addressing potential issues before they escalate into more significant problems.

In some arrangements, the method includes utilizing the generated alerts for corrective action to automatically initiate maintenance protocols or adjustments to system operations. These protocols are specifically designed to address the predicted faults identified by the classification into the fault category, thereby minimizing downtime and preventing potential system failures. This step ensures that the system's response to predicted faults is both timely and appropriate, addressing issues directly and effectively to maintain system integrity and operational efficiency.

In some arrangements, the maintenance protocols include the deployment of software updates, patches, or changes in system configurations, each tailored to the nature of the fault predicted. This ensures that corrective measures are both timely and relevant to the identified issues, providing targeted interventions that address the specific faults detected by the system. By customizing the response to each predicted fault, the system enhances the effectiveness of maintenance actions, ensuring that issues are resolved in a manner that directly addresses the underlying problem.

In some arrangements, the method further incorporates a feedback loop mechanism that monitors the effectiveness of the maintenance protocols and adjustments made in response to the alerts for corrective action. This mechanism allows for continuous learning and adaptation of the system, improving the accuracy of future fault predictions and the efficacy of the corresponding preventive measures. By analyzing the outcomes of maintenance actions and adjustments, the system can identify patterns of success or areas for improvement, refining its predictive algorithms and maintenance strategies to enhance overall reliability and operational efficiency.

In some arrangements, continuous processing of outliers is provided in order to continue analyzing outliers, with the benefit of additional data and logs acquired over time, in order to continue the AI/ML analysis until the signature can be classified as clean or a fault.

In some arrangements, the feedback loop mechanism aggregates performance data post-maintenance or adjustment actions, analyzing this data to identify patterns of success or areas for improvement. The insights gained from this analysis are then used to refine the AI/ML engine's predictive algorithms, enhancing the system's overall reliability and operational efficiency. This continuous improvement process ensures that the system remains effective in predicting and addressing potential faults, adapting to changing operational conditions and emerging challenges to maintain optimal performance.

In some arrangements, the method also includes the generation of comprehensive reports detailing the outcomes of the corrective actions and the system's performance post-intervention. These reports are designed for review by system administrators, providing actionable insights and recommendations for further system enhancements. By fostering an informed approach to system maintenance and optimization, these reports enable administrators to make data-driven decisions that improve the system's resilience and operational effectiveness, ensuring that maintenance actions are aligned with the system's overall performance objectives and operational needs.

In some arrangements, a system for predictive maintenance and fault detection includes a data collection subsystem configured to aggregate operational data from a wide array of data sources. This subsystem is the foundation of the system, designed to ensure a comprehensive collection of operational information that reflects the system's current state and performance metrics. By gathering data from diverse sources, the system can form a holistic view of operational health, essential for effective predictive analysis.

In some arrangements, the method further comprises a real-time monitoring component of system operations and logs to dynamically capture operational data and system states. This enhancement provides a continuous feed into the Edge Computing Analytics Data Collection Server, ensuring that the data preprocessing step is informed by the most current and comprehensive view of the system's operational status. The inclusion of real-time monitoring capabilities allows for the detection of emerging issues and trends in operational data, facilitating a more proactive approach to predictive maintenance and fault detection. This ensures that the system remains responsive to immediate operational changes, enhancing the accuracy and timeliness of maintenance actions based on the most up-to-date information available.

In some arrangements, the system comprises an edge computing analytics module tasked with preprocessing the aggregated data. This module is responsible for extracting logs and structuring the collected data, preparing it for subsequent analysis. The edge computing analytics module plays a critical role in refining the raw data, filtering out irrelevant information, and structuring the remaining data in a way that enhances its analytical value. This step is relevant for ensuring that the data analysis is both efficient and focused on relevant operational insights.

In some arrangements, a supplemental data subsystem is included to enhance the structured data with additional context through integration with external databases and third-party data services. This subsystem enriches the primary operational data with broader contextual information, offering a more nuanced understanding of the operational environment. By incorporating external data sources, the system gains the ability to consider a wider range of factors in its predictive analysis, improving the accuracy and relevance of its maintenance predictions.

In some arrangements, the system features an ontology-based data organization module that applies a structured set of relationships and hierarchies to the enhanced data. This module prepares the data for detailed analysis by organizing it according to a predefined ontology, which outlines the relationships between different data entities. This structured approach to data organization is essential for generating meaningful insights from the data, as it facilitates the identification of patterns and correlations that might otherwise remain obscured.

In some arrangements, a knowledge graph construction module is included to transform the organized data into a visual and computational graph. This module represents the relationships between data points, highlighting the interdependencies and potential points of failure within the system. The knowledge graph serves as a critical tool for visualizing the complex relationships inherent in the operational data, providing a foundation for the advanced analytical processes that follow.

In some arrangements, the system is equipped with a quantum computing analysis module that utilizes algorithms for Hamiltonian transformation and parameterized evolution. This module is designed to extract complex, correlated relationships from the knowledge graph, leveraging the advanced capabilities of quantum computing to uncover patterns and correlations beyond the reach of traditional computing methods. The quantum computing analysis module represents a significant advancement in data analysis, offering the potential to significantly enhance the system's predictive capabilities.

In some arrangements, a GTN is utilized, featuring a multi-head attention mechanism to analyze the quantum-extracted relationships. This network identifies spatio-temporal patterns indicative of potential system faults, representing a key component of the system's predictive maintenance capabilities. By analyzing the relationships and patterns identified through quantum computing, the GTN can pinpoint potential issues with a high degree of accuracy, facilitating timely and targeted maintenance actions.

In some arrangements, the system includes a classification and alerting engine that processes the findings of the GTN to categorize the data into clean, fault, or outlier segments. This engine generates appropriate alerts for preemptive maintenance actions or detailed reports for further assessment, ensuring that the system's maintenance responses are both informed and timely. By classifying the data and generating alerts based on the GTN's analysis, the system can proactively address potential faults before they result in system failure, enhancing operational reliability and efficiency.

In some arrangements, the system further comprises a maintenance scheduling interface that communicates with maintenance management systems. This interface allows for the automated scheduling of preventive maintenance actions based on the prioritized alerts, streamlining the maintenance process, and minimizing system downtime. By automating the scheduling of maintenance actions, the system ensures that maintenance efforts are efficiently coordinated and effectively targeted, reducing the impact of maintenance activities on system operations while addressing potential issues in a timely manner.

In some arrangements, one or more various steps or processes disclosed herein can be implemented in whole or in part as computer-executable instructions (or as computer modules or in other computer constructs) stored on computer-readable media. Functionality and steps can be performed on a machine or distributed across a plurality of machines that are in communication with one another.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 depicts a first, architectural, flow diagram showing sample interactions, interfaces, steps, functions, and components in accordance with one or more aspects of this disclosure.

FIG. 2 depicts a second, architectural, flow diagram showing sample interactions, interfaces, steps, functions, and components in accordance with one or more aspects of this disclosure that focuses on the AI/ML engine's detail processing steps.

FIG. 3 depicts a third, architectural, flow diagram showing sample interactions, interfaces, steps, functions, and components in accordance with one or more aspects of this disclosure that delves into the quantum correlated relationship extraction.

FIGS. 4A-4B depict a flow diagram for predictive maintenance and fault detection in accordance with one or more aspects of this disclosure.

FIG. 5 depicts a flow diagram for a predictive maintenance process in accordance with one or more aspects of this disclosure.

### DETAILED DESCRIPTION

The subsequent description of different embodiments aims to achieve the aforementioned goals, with reference to accompanying drawings that are integral to this document. These drawings illustrate several ways in which the disclosed information can be implemented. It should be recognized that alternative embodiments are possible, and modifications to structure and function can be made. This description mentions various connections between elements, which should be understood as broad and, unless otherwise indicated, can be direct or indirect, wired, or wireless. This specification is not meant to restrict these connections.

Throughout this document, the term “computers,” “machines,” or similar references are used interchangeably, depending on the context, to denote devices that may be general-purpose, customized, configured for specific purposes, virtual, physical, or capable of accessing networks. These include all associated hardware, software, and components as would be recognized by someone skilled in the field. Such devices might be equipped with one or more application-specific integrated circuits (ASICs), microprocessors, cores, or executors for running, accessing, controlling, or implementing various software, instructions, data, modules, processes, or routines as described herein. The references in this text are not to be seen as restrictive or exclusive to any particular type(s) of electronic device(s) or component(s) and should be understood in the broadest sense as per the knowledge of skilled individuals. Details on specific or general computer/software components, machines, etc., are omitted for conciseness and because they are assumed to be within the understanding of competent professionals in the field.

Software, computer-executable instructions, data, modules, processes, and similar elements can reside on physical storage media that is tangible and computer readable. This includes local memory, network-attached storage, and various forms of accessible memory whether removable, remote, cloud-based, or available through other means. Such elements can be stored in either volatile or non-volatile memory types and can operate in various modes such as autonomously, on-demand, on a schedule, spontaneously, proactively, or reactively. They may be stored collectively or dispersed across different computers or devices, encompassing their memory and additional components. Furthermore, these elements can also be stored or distributed across network-accessible storages, within distributed databases, big data environments, blockchains, or distributed ledger technologies, either in a similar fashion or via distributed means.

In this disclosure, the term “networks” or the like encompasses a variety of communication infrastructures, including local area networks (LANs), wide area networks (WANs), the Internet, cloud networks, both wired and wireless networks, digital subscriber line (DSL) networks, frame relay networks, asynchronous transfer mode (ATM) networks, and virtual private networks (VPN). These can be interconnected directly or indirectly. Networks may feature distinct interfaces tailored for internal, external, and management communications, with the option to assign virtual IP addresses (VIPs) to each as needed. The infrastructure of a network comprises various hardware and software components, including but not limited to access points, adapters, buses, ethernet adapters (both physical and wireless), firewalls, hubs, modems, routers, and switches. These components can be located within the network, at its edges, or externally. Additionally, software and computer-executable instructions operate on these components, facilitating network functions. Networks are capable of supporting HTTPS and various other communication protocols suitable for packet-based transmission and communication.

As used herein, Generative Artificial Intelligence (AI) or the like refers to AI techniques that learn from a representation of training data and use it to generate new content that is similar to or inspired by existing data. Generated content may include human-like outputs such as natural language text, source code, images/videos, and audio samples. Generative AI solutions typically leverage open-source or vendor sourced (proprietary) models, and can be provisioned in a variety of ways, including, but not limited to, Application Program Interfaces (APIs), websites, search engines, and chatbots. Most often, Generative AI solutions are powered by Large Language Models (LLMs) which were pre-trained on large datasets using deep learning with over 500 million parameters and reinforcement learning methods. Any usage of Generative AI and LLMs is preferably governed by an Enterprise AI Policy and an Enterprise Model Risk Policy.

Generative artificial intelligence models have been evolving rapidly, with various organizations developing their own versions. Sample generative AI models that can be used in accordance with various aspects of this disclosure include but are not limited to: (1) OpenAI GPT Models: (a) GPT-3: Known for its ability to generate human-like text, it's widely used in applications ranging from writing assistance to conversation. (b) GPT-4: An advanced version of the GPT series with improved language understanding and generation capabilities. (2) Meta (formerly Facebook) AI Models—Meta LLaMA (Language Model Meta AI): Designed to understand and generate human language, with a focus on diverse applications and efficiency. (3) Google AI Models: (a) BERT (Bidirectional Encoder Representations from Transformers): Primarily used for understanding the context of words in search queries. (b) T5 (Text-to-Text Transfer Transformer): A versatile model that converts all language problems into a text-to-text format. (4) DeepMind AI Models: (a) GPT-3.5: A model similar to GPT-3, but with further refinements and improvements. (b) AlphaFold: A specialized model for predicting protein structures, significant in the field of biology and medicine. (5) NVIDIA AI Models—Megatron: A large, powerful transformer model designed for natural language processing tasks. (6) IBM AI Models—Watson: Known for its application in various fields for processing and analyzing large amounts of natural language data. (7) XLNet: An extension of the Transformer model, outperforming BERT in several benchmarks. (8) GROVER: Designed for detecting and generating news articles, useful in understanding media-related content. These models represent a range of applications and capabilities in the field of generative AI. One or more of the foregoing may be used herein as desired. All are considered to be within the sphere and scope of this disclosure.

Generative AI and LLMs can be used in various aspects of this disclosure performing one or more various tasks, as desired, including: (1) Natural Language Processing (NLP): This involves understanding, interpreting, and generating human language. (2) Data Analysis and Insight Generation: Including trend analysis, pattern recognition, and generating predictions and forecasts based on historical data. (3) Information Retrieval and Storage: Efficiently managing and accessing large data sets. (4) Software Development Lifecycle: Encompassing programming, application development, deployment, along with code testing and debugging. (5) Real-Time Processing: Handling tasks that require immediate processing and response. (6) Context-Sensitive Translations and Analysis: Providing accurate translations and analyses that consider the context of the situation. (7) Complex Query Handling: Utilizing chatbots and other tools to respond to intricate queries. (8) Data Management: Processing, searching, retrieving, and utilizing large quantities of information effectively. (9) Data Classification: Categorizing and classifying data for better organization and analysis. (10) Feedback Learning: Processes whereby AI/LLMs improve performance based on feedback it receives. (Key aspects can include, for example, human feedback, Reinforcement Learning, interactive learning, iterative improvement, adaptation, etc.). (11) Context Determination: Identifying the relevant context in various scenarios. (12) Writing Assistance: Offering help in composing human-like text for various forms of writing. (13) Language Analysis: Analyzing language structures and semantics. (14) Comprehensive Search Capabilities: Performing detailed and extensive searches across vast data sets. (15) Question Answering: Providing accurate answers to user queries. (16) Sentiment Analysis: Analyzing and interpreting emotions or opinions from text. (17) Decision-Making Support: Providing insights that aid in making informed decisions. (18) Information Summarization: Condensing information into concise summaries. (19) Creative Content Generation: Producing original and imaginative content. (20) Language Translation: Converting text or speech from one language to another.

FIGS. 1-3 detail the processes and architecture of a quantum transformation-based system for extracting correlated relationships to preempt failures. FIG. 1 outlines the data collection phase, showing sources like laptops, servers, and workstations funneling data into an Edge Computing Analytics Data Collection Server. This server processes the data, which is then merged with supplemental data, creating an output for the AI/ML Engine. Depending on the AI/ML engine's fault prediction, an alert is generated for corrective action, or documentation/reports are produced.

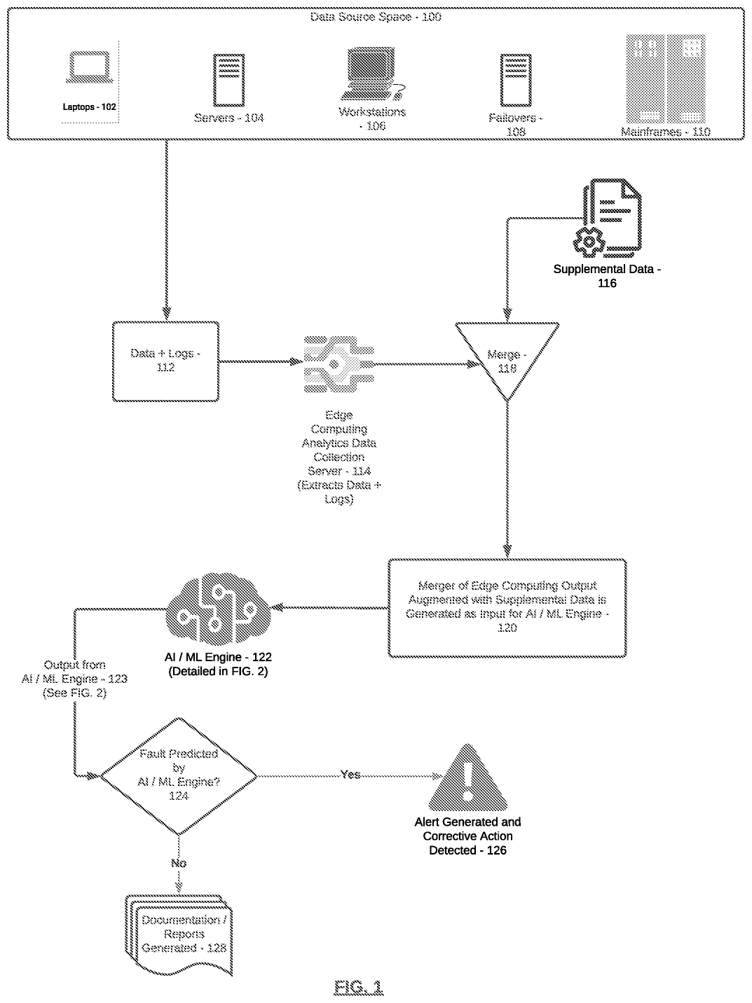

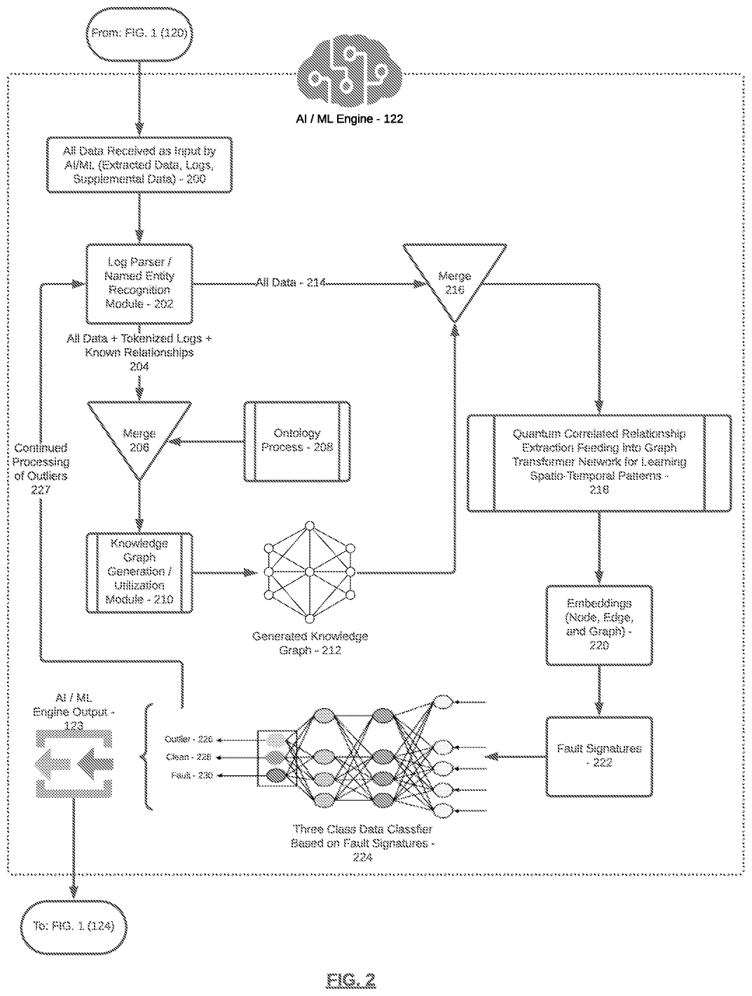

FIG. 2 focuses on the AI/ML Engine's detailed processing steps, including log parsing, named entity recognition, and the generation of a knowledge graph. It highlights the transformation of all received data into a format suitable for deep analysis, ultimately leading to a three-class data classifier based on fault signatures.

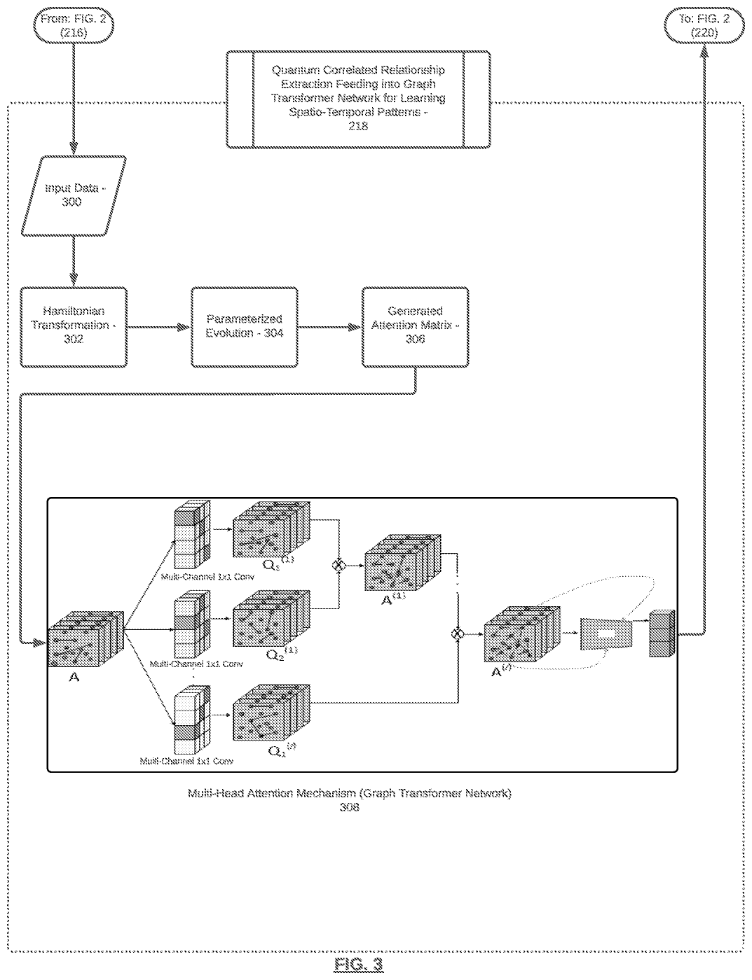

FIG. 3 delves into the quantum correlated relationship extraction, showcasing steps like Hamiltonian transformation, parameterized evolution, and the generation of an attention matrix. It also illustrates the multi-head attention mechanism within the Graph Transformer Network (GTN), emphasizing the system's capability to learn spatio-temporal patterns for predicting failures.

These figures collectively illustrate a sophisticated system designed to predict and preempt failures by processing and analyzing data through advanced AI/ML techniques, quantum computing methodologies, and graph transformer networks.

More granularly, and by way of non-limiting disclosure, FIG. 1 depicts an architectural flow diagram showing sample interactions, interfaces, steps, functions, and components in accordance with one or more aspects of this disclosure. This figure outlines a comprehensive process for collecting, processing, and analyzing data to preempt failures within a system, emphasizing the integration of various data sources and the initial steps toward predictive analysis.

Data Source Space 100 can include any type of of data-generating devices and systems (or related storage systems holding data), including: Laptops 102 (e.g., personal computing devices as sources of user-generated data and logs); Servers 104 (e.g., centralized systems that manage network resources and data; Workstations 106 (e.g., high-performance computers designed for technical or scientific applications); Failovers 108 (e.g., systems in place to ensure data availability and system functionality in case of a primary system failure; Mainframes 110 (e.g., high-capacity computers used for large-scale computing purposes such as bulk data processing and transaction processing), etc. These and like components are constantly producing data and generating logs. In most organizations, this is a continuous and massive explosion of data and logs. This data, together with various logs produced by these components, is collected by an edge computing device.

Edge Computing Analytics Data Collection Server 114 extracts data and logs (Data+Logs—112) from the aggregation of raw data and log files from the various sources listed above, forming the basis for the system's data analysis. This server signifies the edge computing layer where data is preliminarily processed closer to its source to reduce latency and bandwidth use.

Edge computing devices are preferred because they are designed to be located as close as possible to the data source, which in this context means the physical devices generating the data. This proximity ensures that the data can be collected and processed with minimal latency and reduces the risk of data loss during transmission. By situating the edge computing device near the data sources, The system can quickly and efficiently gather all necessary data and supplemental information, creating a comprehensive dataset that forms the basis for all further processing and analysis activities.

This approach contrasts with using a standard analytics server, which might not be located near the data sources and could result in increased data transmission times and higher risks of data loss. Edge Computing Analytics Data Collection Server 114 thus offers a more effective solution for real-time or near-real-time data processing needs, ensuring that the data collected is as complete and current as possible. This setup is helps maintain the integrity and reliability of the data analysis and the insights derived from it, which benefit the system's overall performance and the effectiveness of any predictive maintenance or fault detection processes.

Supplemental Data 116 represents additional data inputs that are integrated with the primary data sources to enrich the analysis. This can include external databases, third-party data services, or other relevant information that enhances predictive accuracy.

Merge 118 and Merger of Edge Computing Output Augmented with Supplemental Data 120 correspond to steps combining the processed data from the Edge Computing server with the supplemental data, preparing a comprehensive dataset for advanced analysis. This merged data is relevant for developing a holistic view of the system's state and potential failure points.

The prepared dataset is then fed into an Artificial Intelligence/Machine Learning Engine 122, detailed in FIG. 2. This AI/ML Engine applies advanced algorithms to analyze the data, identify patterns, predict potential failures, and determine whether corrective action is needed. At a high level, the engine operates by continuously analyzing the data generated from various sources. As this data is produced, the engine performs an initial parsing, processing the data to discern relationships and identify any emergent patterns or potential fault signatures. Once a particular pattern or fault signature is detected, it is fed into a classifier. This classifier is responsible for categorizing the identified pattern as either indicative of a potential fault, a normal operation (clean mechanism), or an outlier that warrants further investigation.

Outliers are possible since no system can perfectly identify every possible error scenario. Thus, the presence of outliers is expected, underscoring the importance of further investigation into these anomalies to maintain system integrity. The output of the AML engine is dependent on the classification results; if a fault is identified, it is reported accordingly. Conversely, if the data does not indicate a fault, it is stored and becomes part of the system's extensive dataset (corpus). This approach underscores the comprehensive nature of the setup, where continuous data generation and analysis facilitate proactive fault detection and system maintenance.

In Decision Point-Fault Predicted by AI/ML Engine 124, based on the AI/ML engine's analysis, a decision is made regarding the presence of a fault. If a fault is predicted, the process triggers an alert for corrective action; if no fault is detected, the system generates documentation and reports for further review or archival purposes.

Alert Generated and Corrective Action Detected 126 is an outcome that signifies the system's proactive response to a detected fault, enabling timely interventions to prevent system failures.

Documentation/Reports Generated 128 is for cases where the analysis does not predict a fault, the system compiles detailed documentation and reports. This output serves various purposes, including performance monitoring, trend analysis, and compliance with regulatory requirements.

FIG. 1 thus illustrates the high-level stages of an exemplary process flow, from data collection through to the determination of potential system faults, setting the foundation for the detailed analysis and predictive actions detailed in subsequent figures.

By way of non-limiting disclosure, FIG. 2 depicts an architectural flow diagram showing sample interactions, interfaces, steps, functions, and components in accordance with one or more aspects of this disclosure that focuses on the AI/ML engine's detail processing steps. This figure highlights sample components and processes within the AI/ML Engine that facilitate the advanced analysis for fault prediction and preventive action guidance.

Identified as “All Data Received as Input by AI/ML 200,” the input stage of FIG. 1 consolidates the data collected from various sources, including extracted data logs and supplemental data, ensuring a comprehensive dataset for analysis. This step marks the transition from raw data collection to the sophisticated processing capabilities of the AI/ML engine.

In the Log Parser/Named Entity Recognition Module 202, at this juncture, the engine employs log parsing techniques to structure the incoming data. The AML engine initiates this analysis with a preliminary preprocessing step, employing natural language processing (NLP) techniques directly on the edge device (or elsewhere if desired). This process is designed to structure the otherwise unstructured log data by parsing it to identify and extract key fields and entities. Utilizing a Large Language Model (LLM), the log parser is able to discern and extract relevant information from the data. This includes error codes, the corresponding error messages, and definitions, as well as the timestamps marking when errors occurred. Additionally, it captures the state of the server at the time of the error and identifies various conditions present within the server, such as other processes running concurrently. This meticulous extraction of entities from the error logs enables a comprehensive analysis of the system's operational health and aids in the identification of potential issues. The process can include:
a. First-Level Pre-Processing: The AML engine begins its analysis by conducting a first-level pre-processing of the data. This step is relevant for preparing the data for more in-depth analysis.
b. Use of NLP: During pre-processing, the engine applies NLP techniques. The goal is to interpret and organize the unstructured log data, which is typically text-heavy and lacks a predefined format.
c. Parsing Unstructured Log Data: This step involves parsing the unstructured log data to identify and extract specific key fields and entities. Parsing is the process of breaking down data into smaller elements for easy manipulation or understanding.
d. Employment of a Large Language Model (LLM): To effectively parse and extract information from the logs, the engine utilizes a Large Language Model. LLMs are advanced AI models capable of understanding and generating human-like text based on the data they have been trained on. These models are particularly adept at discerning the context and meaning of text, making them valuable for processing complex log data.
e. Extraction of Key Information: The LLM identifies and extracts vital information from the logs, such as error codes, error messages and their definitions, timestamps of when errors occurred, the server's state at the time of the error, conditions present within the server, and other concurrent server processes. This information is critical for diagnosing issues and understanding the operational state of the system at the time of the error.

By applying NLP and utilizing an LLM for the initial pre-processing of log data, the AML engine can transform unstructured, text-heavy log data into a structured format. This structured data is easier to analyze and provides a comprehensive overview of the system's performance and potential issues, laying the groundwork for further analysis and decision-making processes within the predictive maintenance and fault detection framework.

Following the initial preprocessing, a technique known as Named Entity Recognition (NER) is utilized. NER serves to pinpoint specific common elements within the data, such as server names, IP addresses, various system modules, the functions associated with an error occurrence, specific error codes, device names, operational parameters, and even the set of users logged into the system at the time of the error. These elements are referred to as common nodes and are considered named entities within the context of the data. These entities can be predefined within the LLM, which then utilizes this definition as a foundation for its analysis. Consequently, NER extracts these identified values from the LLM, highlighting the importance of these entities by isolating them from the broader dataset. This step is relevant for understanding the operational context surrounding errors and system performance, providing a clear view of the interactions and dependencies within the system.

This dual process of log parsing and named entity recognition transforms the raw data into a tokenized and semantically enriched format, laying the groundwork for complex relationship mapping.

In “All Data+Tokenized Logs+Known Relationships” 204, the outcome of the log parsing and NER processes is a dataset that not only maintains its original integrity but is now enhanced with tokenized logs and a preliminary mapping of known relationships among the entities. This enriched dataset is pivotal for the subsequent stages of deep analysis.

In Merge 206 and Ontology Process 208, following the enrichment process, the data undergoes a merging phase where it is combined with additional datasets as needed. The ontology process that follows organizes the data according to a structured model that delineates clear relationships and hierarchies among the entities. This structured approach is fundamental for generating a robust knowledge graph that accurately represents the system's operational dynamics.

In Knowledge Graph Generation/Utilization Module 210, with the data fully prepared, this module generates a knowledge graph that visualizes the complex interrelations and dependencies within the system. This graph is not static; it is utilized dynamically by the AI/ML engine to continuously refine its understanding of the system's operational patterns and potential fault lines.

The advantage of a knowledge graph is its capacity to integrate and analyze diverse types of data within a single framework. Knowledge graphs are data structures that represent information in a graph format, where entities (nodes) are connected by relationships (edges). This format is particularly well-suited to handling heterogeneous datasets, which are composed of different types of data that may not share a common structure or format.

The knowledge graph is able to accommodate and link various data elements—ranging from numerical data, text, and images to more complex data types like temporal data and geospatial information—without losing the context or meaning of the data. This capability facilitates understanding the interrelationships between different data types and can provide insights into system behavior, potential issues, and operational efficiencies.

In essence, use of a knowledge graph in this disclosure enables disparate pieces of data to be integrated into a cohesive, interconnected whole. This allows for more sophisticated analysis, better decision-making, and the uncovering of insights that might not be apparent when examining the data in isolation. New and distinct elements can be seamlessly integrated into the existing structure of the knowledge graph, where each addition is represented as a unique node with its own set of attributes. This new node effectively forms its own micro-ecosystem within the larger context of the knowledge graph. The process allows for the continuous expansion of the knowledge graph by adding multiple diverse entities, enhancing its complexity and utility. This level of flexibility is particularly beneficial, offering significant advantages as the analysis progresses to subsequent stages, where the ability to incorporate varied data types and sources becomes increasingly valuable.

Generated Knowledge Graph 212 is the product of the previous stage and can be a detailed knowledge graph that serves as a map of the system's operational health. This graph is instrumental in identifying non-obvious relationships and patterns that could indicate potential faults or areas requiring preventive measures.

In “Quantum Correlated Relationship Extraction Feeding into Graph Transformer Network for Learning Spatio-Temporal Patterns” 218, this stage represents the cutting edge of the system's analytical capabilities. By employing quantum computing techniques, the engine extracts deep, correlated relationships from the knowledge graph.

More specifically, the input to 218 is is directed towards a Quantum Correlated Extractor, together with various data elements, to unveil deeper and more intricate relationships among entities. The quantum correlation technique leverages prior knowledge about the nature of relationships, enhancing the detection of uncommon relations and improving the model's ability to generalize. This aspect is particularly relevant for identifying transitive or possessive relationships, which are prevalent in numerous datasets. Entities' relationships are often complexly intertwined within a high-dimensional space, where quantum representation through qubits excels in learning expansive distributed representations.

Subsequently, the Quantum Correlated Graph Transformer Network assimilates this processed information to predict various fault signatures. This predictive capability is instrumental in identifying different potential issues within the system, showcasing the profound impact of quantum correlation in enhancing fault detection and analysis. These relationships are then analyzed by the GTN, which learns the spatio-temporal patterns relevant for predicting potential system faults.

More specifically, at the initial stage, the process involves collecting data and forwarding it to the Quantum Correlated Graph Transformer Network (GTN). This network ingests the graph, transforming it into a quantum Hamiltonian representation, which mathematically models the current system state, essentially capturing its energy state through linear and quadratic coefficients. This is achieved using a Quadratic Unconstrained Binary Optimization (QUBO) model, facilitating probabilistic sampling across datasets to elucidate the best possible relationships among them.

The formation of the Hamiltonian precedes the derivation of dynamics or relationships among its parameters, employing quantum sampling to measure the correlation between various parameters at each stage of parameterized evolution. These correlations are then compiled into a quantum attention matrix, which, as data continually flows into the AML engine, allows for iterative updates that incorporate new relationships identified among the qubits.

The quantum correlation method, employing Hamiltonian representation, is exceptionally effective at deciphering the structure of facts from natural language and unstructured or semi-structured data. It excels in drawing inferences because qubits maintain chains of relationships more effectively, thereby facilitating superior inferential learning of intricate relationships.

As the knowledge graph expands to include new parameters, reflecting the system's capacity to handle diverse data formats, these parameters are added to the qubit count, enriching the network's node relationships. This iterative process facilitates the establishment of multi-head attention mechanisms, laying the groundwork for the data's subsequent processing by the graph transformer network.

This network employs spatial convolution and multi-head attention mechanisms to navigate the information landscape, enabling the identification of critical causal relationships and the generation of edge and graph embeddings. These embeddings are crucial for pinpointing fault signatures within the system. The data passes through an encoder comprising multiple layers with multi-head attention mechanisms and feedforward neural networks, which helps capture various dependencies and assign weightages to different components based on their significance. This sophisticated approach allows for a nuanced understanding of the system's operational dynamics and the proactive identification of potential issues.

After processing through this layer, each entity is transformed into a contextualized representation, where “contextualized” refers to the nuanced relationships between the entities. This allows the system to discern various types of relationships, such as causal links where the occurrence of entity X might be triggered by the prior occurrence of entity Y, or scenarios of co-occurrence where two entities either appear together or not at all. This depth of relationship prediction enables the identification of patterns such as dependence and co-occurrence among the entities. The process culminates in an output layer, typically comprising a fully connected layer coupled with a SoftMax activation function, resulting in the generation of node, edge, and graph embeddings.

For reference, the SoftMax function, often used in the field of machine learning and deep learning, is a mathematical function that converts a vector of numerical values into a vector of probabilities. Each element of the output vector of the SoftMax function represents the probability that the corresponding input belongs to a particular class, given a set of classes. The probabilities produced by the SoftMax function add up to 1, making it particularly useful in classification problems where the goal is to determine the likelihood of input data belonging to one of several possible categories.

With these embeddings, the system can be trained on an initial dataset and then evaluated against a labeled dataset, enhancing its ability to accurately predict outcomes based on the identified relationships and patterns.

The SoftMax function is typically applied in the final layer of a neural network model for multi-class classification problems. It takes as input the raw logits (i.e., the unnormalized predictions) from the previous layer of the network and outputs a probability distribution over the predicted classes. The class with the highest probability can then be selected as the model's prediction.

The Embeddings (Node, Edge, and Graph) 220 generated by the GTN encapsulate the essential features of the nodes, edges, and overall graph structure. These embeddings are a compact representation of the system's operational state, capturing both the static and dynamic aspects of the system's behavior. For reference, node embeddings are vector representations of nodes in a graph, capturing their properties and roles within the graph's structure. Edge embeddings similarly represent the connections between nodes, encapsulating the relationship and interaction information. Graph embeddings provide a comprehensive representation of the entire graph, summarizing its overall structure and the interactions between its components. These embeddings enable machine learning models to process and analyze graph-structured data effectively, supporting tasks like prediction, classification, and clustering within the graph's context.

Armed with the insights gleaned from the embeddings, the AI/ML engine identifies specific Fault Signatures 222. Fault signatures are distinctive patterns or indicators that emerge from data analysis, reflecting specific types of system malfunctions or failures. They are extracted from operational data using advanced analytics and are relevant for predictive maintenance strategies. By recognizing these unique signatures, systems can proactively identify potential issues before they lead to significant failures, allowing for timely intervention and maintenance actions to prevent downtimes and improve system reliability. These signatures are indicative of patterns or anomalies that historically correlate with system failures or malfunctions.

Following this process, all the data can be directed to a three-class classifier. This classifier has the capability to sort data patterns based on their fault signatures, determining whether they represent clean data, indicating no issues and allowing processes to continue unaffected; signal a potential fault, suggesting the need for preemptive measures; or identify an outlier, a pattern previously unseen that necessitates further investigation for accurate classification. Depending on the outcome of this classification, appropriate actions are taken, encapsulating the essence of the entire setup. This structured approach enables precise monitoring and maintenance strategies, enhancing system reliability and performance.

Thus, Three-Class Data Classifier Based on Fault Signatures 224 is the culmination of the analysis process and is the classification of the data into three distinct categories: clean (228), indicating normal operation; fault (230), indicating a potential or imminent failure; and outlier (226), indicating data points that deviate significantly from expected patterns and require further investigation.

More specifically, the data flowing continuously from various logs is processed and categorized by a three-class classifier into Clean, Faulty, or Outlier categories. This categorization is achieved by iteratively training the classifier on fault signatures that have been identified. If outliers are detected, processing on the outlier can continue 270 based on additional data and logs generated over time in the future.

Following this, the model is deployed for real-time monitoring and failure prediction purposes. Operators receive notifications when such fault signatures are identified, enabling the activation of early warning systems and the implementation of suitable recovery measures.

AI/ML Engine Output 123 represents the final output from the AI/ML engine and includes detailed fault predictions and a comprehensive analysis of the system's operational health. This output is integral to guiding preventive maintenance actions and ensuring the system's reliability and efficiency.

Thus, FIG. 2 provides a detailed roadmap of the AI/ML Engine's operational flow, from initial data reception through complex analysis and classification, showcasing the depth of processing that enables the system to predict and preempt potential faults with high accuracy.

By way of non-limiting disclosure, FIG. 3 depicts an architectural flow diagram showing sample interactions, interfaces, steps, functions, and components in accordance with one or more aspects of this disclosure that delves into the quantum correlated relationship extraction. FIG. 3 provides an in-depth look at the quantum computing and graph-based analysis phase of the invention. This phase is pivotal for extracting complex, non-linear relationships within the data that are not readily apparent through traditional analysis methods. Here's a detailed breakdown of the components and processes depicted in FIG. 3:

The process of Quantum Correlated Relationship Extraction Feeding into Graph Transformer Network for Learning Spatio-Temporal Patterns 218 represents the innovative approach of combining quantum computing techniques with advanced machine learning (ML) to analyze data. It signifies a critical juncture where quantum-extracted data relationships are utilized to inform the Graph Transformer Network (GTN), enabling it to learn and predict based on spatio-temporal patterns inherent in the data.

Input Data 300 involves the prepared and structured dataset, which is the outcome of prior preprocessing, being introduced to the quantum computing framework. The data is ready for transformation and analysis using quantum algorithms, aiming to reveal hidden correlations that are relevant for fault prediction. Thus, the process begins with the introduction of the graph into the Quantum Correlated Graph Transformer Network's initial layer.

As detailed below, this graph is then converted into a quantum Hamiltonian, establishing the foundational framework of the system. Through each stage of parameterized evolution within the quantum dynamics, the correlations among variables are meticulously quantified and subsequently compiled into a quantum attention matrix. This involves iterative updates that incorporate relationships between qubits, following the process outlined above, leading to the formation of multi-head attention mechanisms. These mechanisms are determined through a linear combination of each preceding correlation vector, alongside a SoftMax layer applied to these combinations. Distinct quantum circuits are employed for each head, utilizing a quantum weighted matrix to refresh values during each iteration.

To guarantee a synchronous assessment of all quantum states, thereby enhancing the measurement of correlations between parameters and, consequently, the relationships among them, the weights of the quantum states' parameters and the classical weight parameters are maintained independently.

The Graph Transformer Network (GTN) assimilates these derived correlations, learning spatial-temporal patterns and feature embeddings crucial for modeling system failure propagation. Through spatial convolution and multi-head attention mechanisms, the GTN aggregates information from multiple neighborhood hops and pinpoints essential causal relationships. This process results in the derivation of Node, Edge, and Graph embeddings crucial for identifying fault signatures.

The encoder component, comprised of several layers each housing multi-head attention mechanisms and feed-forward neural networks, processes the input to elucidate dependencies across various input segments. The multi-head attention mechanism empowers the GTN to assess the significance of different input components, capturing long-range dependencies among entities and the additional data provided by the Quantum Correlated extractor. After encoding, each entity acquires a contextualized representation that encapsulates the inter-entity relationships.

These contextualized representations then facilitate further predictions regarding relationships, including classifications of entity relations or the determination of relationship types (e.g., cause-effect or co-occurrence). The output layer, typically a fully connected layer followed by a SoftMax activation for classification tasks or regression layers for continuous prediction tasks, transforms these entity representations into relationship predictions, generating Node, Edge, and Graph embeddings.

The Quantum Correlated GTN undergoes training with labeled data, adjusting its parameters to reduce prediction errors. Following training, the network is evaluated on a separate test dataset to ascertain its accuracy and performance. Upon satisfying the requisite metrics, it is deployed for real-time analysis of new error logs, showcasing its predictive capabilities.

Thus, in Hamiltonian Transformation 302, the structured input data is converted into a quantum state. This step maps the dataset into a quantum framework, allowing the system to leverage quantum mechanical principles to analyze data at an unprecedented scale and depth. For reference, a Hamiltonian transformation in the context of quantum computing refers to a process or operation that applies the principles of the Hamiltonian function to a system. The Hamiltonian represents the total energy of a system, including both kinetic and potential energy, and is central to the formulation of the system's dynamic behavior over time. In quantum computing, Hamiltonian transformations are used to evolve quantum states, describing how these states change in response to the system's energy dynamics. This concept is key for simulating physical systems and for algorithms that require the manipulation of quantum states based on the system's energy properties.

After the Hamiltonian transformation, the data undergoes Parameterized Evolution 304 which, in quantum computing, refers to the process of evolving quantum states over time, guided by a set of parameters that can be adjusted to optimize the system's behavior for specific goals. This concept is relevant for algorithms that simulate dynamic systems or solve optimization problems by finding the parameter values that lead to the desired evolution of quantum states, thereby revealing solutions or insights into the system's properties. This evolution is key to discovering significant patterns and correlations within the data, enabling the system to identify potential fault precursors that traditional computing might overlook.

Generated Attention Matrix 306 is the result of the quantum processing phase. An attention matrix in the context of machine learning and particularly in models like the GTN, is a computational construct that helps the model focus on different parts of the input data with varying degrees of emphasis or ‘attention’. This matrix is generated as part of the model's process to determine how much importance or weight to assign to various parts of the data when making predictions or analyses. It enables the model to dynamically allocate its attention across the data, improving its ability to learn complex patterns and relationships, especially in tasks involving sequences or structured data like graphs. Here, an attention matrix is generated to highlight the correlations and relationships uncovered among the data points. This matrix serves as a relevant input for the Graph Transformer Network, providing a detailed map of the data's underlying structure and interconnections.

The Multi-Channel 1×1 Convolutions are part of the GTN's analysis process. The multi-channel 1×1 convolution technique is used to process the attention matrix further, optimizing the network's ability to learn from the quantum-extracted relationships by integrating and refining features across different channels of the data. Multi-channel 1×1 convolutions are a type of convolutional operation used to combine and transform features across different channels without changing the spatial dimensions of the input. This operation uses a kernel size of 1×1, effectively serving as a linear transformation of the channels at each spatial location. Multi-channel 1×1 convolutions are useful for dimensionality reduction, feature cross-channel pooling, and increasing network depth while controlling the computational cost, thereby enhancing the model's learning capacity and efficiency.

Multi-Head Attention Mechanism GTN 308 analyzes the attention matrix in-depth. By focusing on various parts of the matrix concurrently, the GTN can capture a comprehensive range of relationship patterns, significantly enhancing the predictive accuracy of potential system faults.

Thus, FIG. 3 outlines a sophisticated approach to data analysis that merges the quantum computing domain with graph-based machine learning. This integration facilitates a deep understanding of complex data relationships, enabling the system to predict and preempt potential failures with high precision, thereby offering a proactive solution for maintaining system reliability and efficiency.

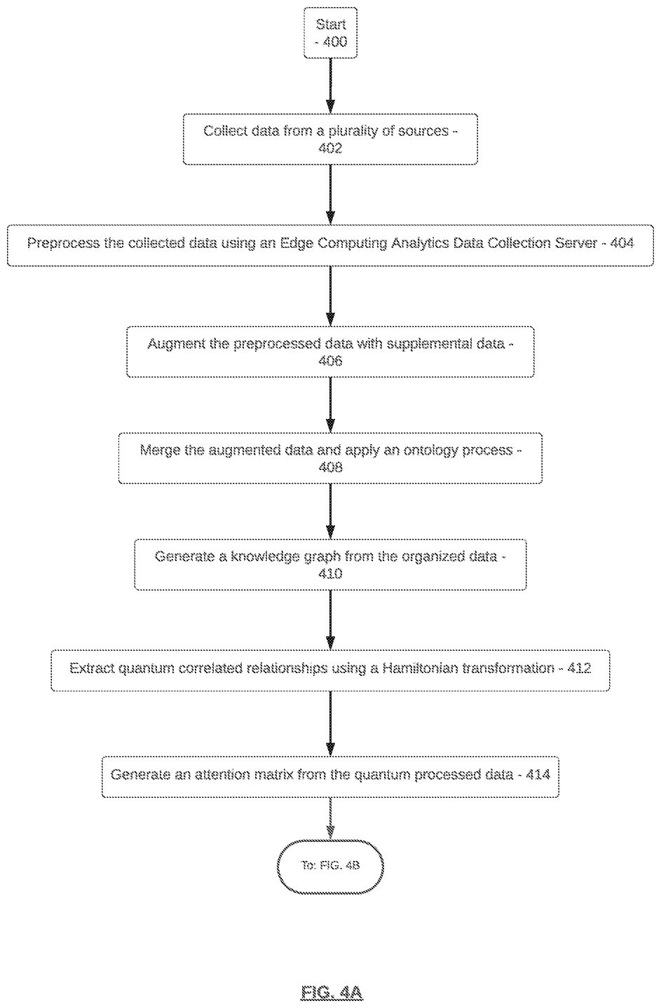

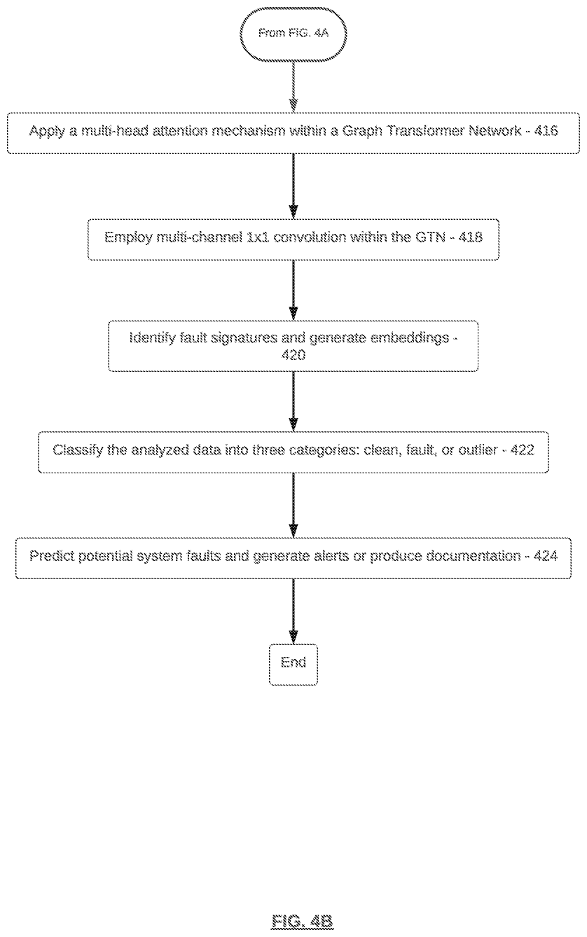

By way of non-limiting disclosure, FIGS. 4A-4B depict a flow diagram for predictive maintenance and fault detection in accordance with one or more aspects of this disclosure. More specifically, FIG. 4, split into parts A and B, outlines a comprehensive process flow for predictive maintenance and fault detection. Starting with data collection from various sources (402), the process includes preprocessing this data with an Edge Computing Analytics Data Collection Server (404), augmenting it with supplemental data (406), and merging the augmented data to apply an ontology process (408). A knowledge graph is then generated (410), from which quantum correlated relationships are extracted using a Hamiltonian transformation (412). This is followed by generating an attention matrix from the quantum-processed data (414). In continuation, a multi-head attention mechanism is applied within a Graph Transformer Network (GTN) (416), with multi-channel 1×1 convolution employed within the GTN (418). The process concludes with identifying fault signatures and generating embeddings (420), classifying the analyzed data into categories: clean, fault, or outlier (422), and predicting potential system faults to generate alerts or produce documentation for further review (424), marking the end of the workflow.

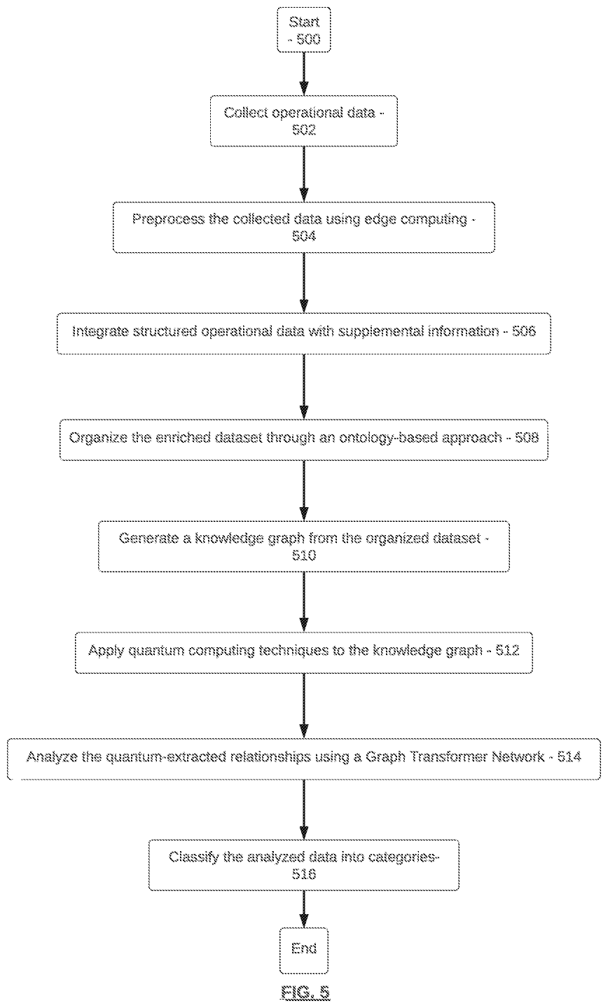

By way of non-limiting disclosure, FIG. 5 depicts a flow diagram for a predictive maintenance process. It starts with collecting operational data (502), then preprocessing this data using edge computing (504). The process continues with integrating structured operational data with supplemental information (506), organizing the enriched dataset through an ontology-based approach (508), and generating a knowledge graph from the organized dataset (510). Quantum computing techniques are applied to the knowledge graph (512), followed by analyzing the quantum-extracted relationships using a Graph Transformer Network (514). The process concludes with classifying the analyzed data into categories (516), marking the end of the process.

A significant advantage of this disclosure is the quantum correlated layer's ability to discern relationships that are virtually unattainable through traditional or classical methods. This capability stems from its proficiency in rapidly evaluating various parameter combinations derived from the graph, thereby efficiently determining the lowest energy state, or ground state, for each Hamiltonian. Consequently, this refined output serves as the foundational input for the subsequent graph transformer network, establishing a dynamic mechanism that perpetually extracts and refines relationships. These relationships, once ingested by the GTN, enable it to accurately predict fault signatures, showcasing the system's advanced analytical prowess.

By employing unsupervised learning techniques to analyze unlabeled log data and system components, the system is able to construct a knowledge graph and uncover complex relationships more rapidly and accurately through quantum correlation. This method surpasses traditional manual modeling, allowing the quantum correlational extractor to discern intricate patterns of interactions leading to system failures. Meanwhile, the graph transformer network elucidates the dynamic interplay between system components by generating node, edge, and graph embeddings. This facilitates the diagnosis of new errors through the identification of pertinent subgraph flows, thereby enabling precise failure predictions by mapping out the interdependencies among components within a complex system. The knowledge graph condenses the data into a structured format, optimizing its utility for analysis.

The integration of Quantum Correlated Graph Transformer Networks heralds a shift towards a more data-centric strategy, harnessing quantum graph-based deep learning to deduce patterns and dependencies responsible for failures. These are often elusive when using conventional analytical techniques, showcasing the transformative potential of quantum-enhanced analytics in understanding and mitigating system failures.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for predictive maintenance and fault detection within a system comprising the steps of:
collecting source data from a plurality of sources;
preprocessing the source data using an edge computing analytics data collection server to extract data logs and structure the data into preprocessed data;
augmenting the preprocessed data with supplemental data to form augmented data to enhance predictive analysis;
merging the augmented data and applying an ontology process to organize the augmented data based on defined relationships and hierarchies into organized data;
generating a knowledge graph from the organized data to visualize and computationally represent the relationships and the entities within the source data;
extracting quantum correlated relationships from the knowledge graph using a Hamiltonian transformation followed by a parameterized evolution process to form quantum processed data;
generating an attention matrix from the quantum processed data;
applying a multi-head attention mechanism within a Graph Transformer Network (GTN) to the attention matrix for analyzing spatio-temporal patterns and learning from the quantum correlated relationships;
employing multi-channel 1×1 convolution within the GTN to process the attention matrix;
generating node embeddings, edge embeddings, and graph embeddings;
identifying a signature based on node embeddings, edge embeddings, and graph embeddings;
classifying the signature into a clean category, a fault category, or an outlier category; and
predicting a potential system fault for any said signature in the fault category.

2. The method of claim 1, further comprising the step of: generating an alert for corrective action based on classification of the signature.

3. The method of claim 2, further comprising the step of: producing documentation based on said classification of the signature.

4. The method of claim 3, further comprising the steps of:
real-time monitoring of the plurality of sources; and
providing a real-time feed into the edge computing analytics data collection server for continuous data preprocessing.

5. The method of claim 4, wherein the supplemental data is integrated based on outcomes of the real-time monitoring relevant to operational context of the system, to enrich the preprocessed data with contextual analysis.

6. The method of claim 5, wherein the quantum correlated relationships are extracted based on non-linear relationships within the source data and the source logs.

7. The method of claim 6, wherein the ontology process, applied to the merged data from the edge computing analytics data collection server augmented with the supplemental data, defines a structured model.

8. The method of claim 7, wherein identification of the signature is based on the node embeddings, edge embeddings, and graph embeddings that generated from the quantum correlated relationships.

9. The method of claim 8, further comprising the step of automatically initiating the corrective action.

10. The method of claim 9, further incorporating a feedback loop mechanism that monitors effectiveness of the corrective action.

11. The method of claim 10, further comprising the step of generating documentation describing the corrective action and system performance post-intervention.

12. A system for predictive maintenance and fault detection, comprising:
a data collection subsystem configured to aggregate operational data from data sources;
an edge computing analytics module tasked with preprocessing the operational data by extracting logs and structuring extracted data into preprocessed data;
an ontology-based data organization module that applies a structured set of relationships and hierarchies to the preprocessed data in order to generate organized data;
a knowledge graph construction module that transforms the organized data into a knowledge graph, visually and computationally representing the relationships in the organized data;
a quantum computing analysis module equipped with algorithms for Hamiltonian transformation and parameterized evolution, that extracts quantum correlated relationships from the knowledge graph;
a graph transformer network (GTN) that utilizes a multi-head attention mechanism to analyze the quantum correlated relationships;
an embedding generator to generate embeddings based on output from the GTN; and
a classification engine that processes the embeddings and categorizes a resulting data signature into a clean category, a fault category, or an outlier category.

13. The system of claim 12 further comprising a notice generator to provide an alert for any said data signature categorized in the fault category.

14. The system of claim 13 wherein corrective action is automatically taken when any said data signature is categorized in the fault category.

15. The system of claim 14, wherein the data collection subsystem further includes real-time monitoring that dynamically captures said operational data.

16. The system of claim 15, wherein the ontology-based data organization module employs an adaptive ontology framework that updates its structure based on evolving data patterns, ensuring that the knowledge graph remains accurate and reflective of current operational dynamics.

17. The system of claim 16, wherein the quantum computing analysis module implements quantum algorithms that are dynamically adjusted based on data observation characteristics to optimize extraction of the quantum correlated relationships for each unique dataset.

18. The system of claim 17, wherein the notice generator includes an automated decision-making process that prioritizes alerts based on severity and immediacy of a predicted fault.

19. The system of claim 18, further comprising a maintenance scheduling interface that communicates with maintenance management systems, allowing for the automated scheduling of preventive maintenance actions based on the alerts and their priorization.

20. A method for predictive maintenance and fault detection in a computing environment, comprising the steps of:
collecting source data and source logs from a plurality of data sources;
preprocessing the source data and the source logs into operational data using an edge computing device to enhance data suitability for in-depth analysis;
organizing the operational data into a structured dataset using an ontology process to establish relationships among data points;
generating a knowledge graph from the structured dataset;
applying quantum computing techniques to the knowledge graph to extract quantum correlated relationships using Hamiltonian transformation and parameterized evolution processes;
analyzing the quantum correlated relationships using a Graph Transformer Network (GTN) equipped with a multi-head attention mechanism to identify spatio-temporal patterns;
classifying, based on the spatio-temporal patterns, a signature for the operational data into a clean category, a potential fault category, or an outlier category;
augmenting the source data and the source logs for any said signature in the outlier category with additional data and additional logs;
continuing analysis, for any said signature classified in the outlier category, until the operational data, augmented with the additional data and additional logs, generates a new signature that can be classified in either the clean category or the potential fault category; and
initiating a corrective action for any classification of said signature in said potential fault category.
